(19) United States
(12) Patent Application Publication
(10) Pub. No.: US 2010/0248714 A1
(43) Pub. Date: Sep. 30, 2010

(54) METHOD OF TRANSMITTING SIGNAL IN SATELLITE COMMUNICATION SYSTEM WITH TERRESTRIAL COMPONENT

(75) Inventors: Yeon Su Kang, Daegu (KR); Kun Seok Kang, Daejeon (KR); Do-Seob Ahn, Daejeon (KR); Ho Jin Lee, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/746,316

(22) PCT Filed: Sep. 29, 2008
(86) PCT No.: PCT/KR2008/005737

§ 371 Date: Jun. 4, 2010

(30) Foreign Application Priority Data
Dec. 13, 2007 (KR) 10-2007-0130388

(51) Int. Cl. H04W 4/00

(52) U.S. Cl. 455/427

(57) ABSTRACT

The present invention relates to a method of transmitting a signal in a satellite communication system with a terrestrial component. The present invention transmits a signal using a method of transmitting a space-time code for joint communication between a satellite and a terrestrial component in a satellite system with a terrestrial component. Therefore, using the method of transmitting a space-time code, it is possible to obtain a space-time diversity gain in a satellite communication system with a terrestrial component. Further, it is possible to improve the receiving quality of a satellite signal at an area where the terrestrial component is located and increase the coverage of the terrestrial component.

### TECHNICAL FIELD

The present invention relates to a satellite communication system with a terrestrial component, and particularly to a method of transmitting a signal with a space-time code in a communication system.

The present invention is derived from a work that was supported by the IT R&D program of MIC/IITA [2005-S-014-03, Technology Development of Satellite IMT2000+].

### BACKGROUND ART

A satellite digital multimedia broadcasting (DMB) system, a digital video broadcasting satellite service to handhelds (DVB-SH) system, and a geostationary orbit (GEO)-based mobile satellite communication system have been known in the art as mobile satellite communication systems that allow communication between a satellite and a terminal, using a complementary terrestrial component (CTC) such as a repeater, a complementary ground component (CGC), or an ancillary terrestrial component (ATC).

A satellite DMB system that has been already providing services provides a highquality audio signal and a multimedia signal to users, using a satellite and a complementary terrestrial component that uses an on-channel repeater (gapfiler). The on-channel repeater is used to effectively solve the coverage of a shadow area. In order to provide the service, frequency bandwidths of the satellite and the terrestrial system are optimized in the range of 2630 to 2655 MHz.

A satellite DMB system is composed of a feeder link earth station, a broadcasting satellite, a terrestrial repeater, and a terminal for receiving a service. A signal outputted from the terminal is transmitted to the satellite through the feeder link earth station, in which an uplink has a bandwidth for a fixed satellite service (FSS) of, for example, 14 GHz. The satellite converts the received signal into a signal having a bandwidth of 2.6 GHz, and the converted signal is amplified to a predetermined magnitude by an amplifier in a satellite repeater and then transmitted to a terminal located in a service area.

The terminal should be able to receive a signal outputted from the satellite through a low-directional small antenna. To achieve the terminal, sufficiently effective isotropic radiated power should be provided. Therefore, the satellite should be provided with a large transmitting antenna and a high-power repeater.

When the satellite outputs a signal having a bandwidth of 2.6 GHz, a shading area is caused by an obstacle on a direct path from the satellite. To overcome this problem, a repeater that re-transmits a satellite signal is added in system design. The repeater allows the signal to be transmitted to an area that the signal outputted from the satellite cannot reach by a bandwidth obstacle, such as a building, and is divided into a direction amplifying repeater and a frequency converting repeater.

The direct amplifying repeater only amplifies the signal having a bandwidth of 2.6 GHz that is received from the satellite. The direction amplifying repeater uses a low-gain amplifier to prevent unnecessary divergence due to signal interference generated between a receiving antenna and a transmitting antenna. The direct amplifier is in charge of a narrow area spaced by 500 m from the repeater within the line of sight (LoS).

On the contrary, the frequency converting repeater is in charge of a wide area spaced by 3 km, and converts the signal having a bandwidth of 2.6 GHz outputted from the satellite into another bandwidth of, for example, 11 GHz, and transmits it to the terminal. When two types of repeaters are used as described above, multipath fading in which two or more signals are transmitted to the terminal is caused.

The DVB-SH system, another mobile satellite communication system, is designed to provide a service using a satellite for a nationwide coverage and to provide a service to a terminal using a CGC for an indoor condition or terrestrial coverage. The DVB-SH system provides a mobile TV service in a bandwidth of 15 MHz of an S bandwidth, on the basis of DVB-H. The DVB-SH system uses a bandwidth close to the bandwidth used in terrestrial international mobile telecommunication (IMT) of the S bandwidth. Therefore, integration with the terrestrial IMT and reuse of the network with the terrestrial system are easy, such that the installation cost is reduced.

Further, hybrid broadcasting with a terrestrial system has been considered. Further, to solve signal interference between the satellite and the CGC and efficiently use the frequency, it has been considered that a reuse factor is set to as 1 for a CGC cell in one satellite spot beam and as 3 for the satellite spot beam. According to this configuration, broadcasting to the terrestrial repeater is possible through 9 TV channels for the nationwide coverage and 27 channels for a downtown or an indoor condition.

Finally, the GEO-based mobile satellite communication system has been developed in mobile satellite ventures (MSV) and Terrestar to provide a ubiquitous wireless wide area communication service, such as an Internet connection service and a voice communication service, to a terminal in an L bandwidth and an S bandwidth. The system provides a voice service or a high-speed packet service through an ATC, i.e., a terrestrial system for a downtown or a highly populated district, using a hybrid wireless network that is achieved by combination of a satellite with the ATC, and provides a service to a countryside or a suburb that cannot be covered by the ATC, through a satellite. Because the ATC uses a wireless interface such as the satellite, development is occurring to be able to provide a satellite service without increasing complexity of the configuration of a terrestrial terminal.

### DISCLOSURE OF INVENTION

### Technical Problem

The present invention has been made in an effort to provide a method of transmitting a space-time code having advantages of improving the receiving quality of signals at an area where signals of a satellite and a terrestrial component can be received, using space-time coding in a satellite communication system with the terrestrial component.

### Technical Solution

In order to achieve the technical object, the present invention provides a method of transmitting a signal in a communication system with a plurality of terrestrial components, which includes generating a first group of transmission signals on the basis of a first symbol index for a first transmission signal and a second symbol index for a second transmission signal to transmit to the terminal; generating a second group of transmission signals on the basis of the first symbol index and the second symbol index, generating a third group of transmission signals on the basis of a first transmission data symbol and a second transmission data symbol that are obtained by operating the first symbol index and the second symbol index, and generating a space-time code including the first group of transmission signals, the second group of transmission signals, and the third group of transmission signals, and then transmitting the space-time code to the terminal.

The present invention provides a method of transmitting a signal to a terminal in a satellite communication system with a plurality of terrestrial components, including generating a first group of transmission signals that is directly transmitted to the terminal, on the basis of a first symbol index for a first transmission signal and a second symbol index for a second transmission signal to transmit to the terminal, generating a second group of transmission signals that is transmitted to the terminal through the terrestrial component, on the basis of the first symbol index and the second symbol index, generating a third group of transmission signals that is transmitted to the terminal through the terrestrial components, on the basis of a first transmission data symbol and a second transmission data symbol that are obtained by operating the first symbol index and the second symbol index, and generating a space-time code comprising the first group of transmission signals, the second group of transmission signals, and the third group of transmission signals, and transmitting the space-time code to the terminal and the terrestrial components.

### ADVANTAGEOUS EFFECTS

Therefore, using space-time coding, it is possible to obtain a space-time diversity gain in a satellite communication system with a terrestrial component.

Further, it is possible to improve the receiving quality of a satellite signal at an area where the terrestrial component is located and increase the coverage of the terrestrial component.

### BRIEF DESCRIPTION OF THE DRAWINGS

FIG. 1 is a diagram illustrating a satellite communication system according to an exemplary embodiment of the present invention.

FIG. 2 is a schematic view illustrating application of a space-time code according to an exemplary embodiment of the present invention.

FIG. 3 is a flowchart illustrating a method of transmitting/receiving a space-time code according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprises” and/or “comprising,” when used in this specification, specify the presence of stated components, but do not preclude the presence or addition of one or more other components, unless specifically stated. In addition, the terms “-er”, “-or”, and “module” described in the specification mean units for processing at least one function and operation and can be implemented by hardware components or software components and combinations thereof.

A mobile station (MS) herein may designate a terminal, a mobile terminal (MT), a subscriber station (SS), a portable subscriber station (PSS), user equipment (UE), or an access terminal (AT), and may include functions of a portion of or all of the mobile terminal, the subscriber station, the portable subscriber station, and the user equipment.

A technology according to an exemplary embodiment of the present invention transmits a signal, in a joint transmission, between a satellite and terrestrial components. Therefore, a system environment according to an exemplary embodiment of the present invention can be applied to an area where a terrestrial component is located, and the existing method of satellite communication is applied to an area without a terrestrial component. Further, a satellite communication system is described as an example in an exemplary embodiment of the present invention, but the invention is not limited thereto.

The terrestrial component herein includes both a simple repeater that transmits a satellite signal for a shading area and a repeater that has a similar function to a base station in a terrestrial network. As examples of the terrestrial component having the above function, a DMB repeater, an intermediate modular repeater (IMR), a complementary ground component (CGC), and an ancillary terrestrial component (ATC) have been known in the art, but the terrestrial component is not limited thereto.

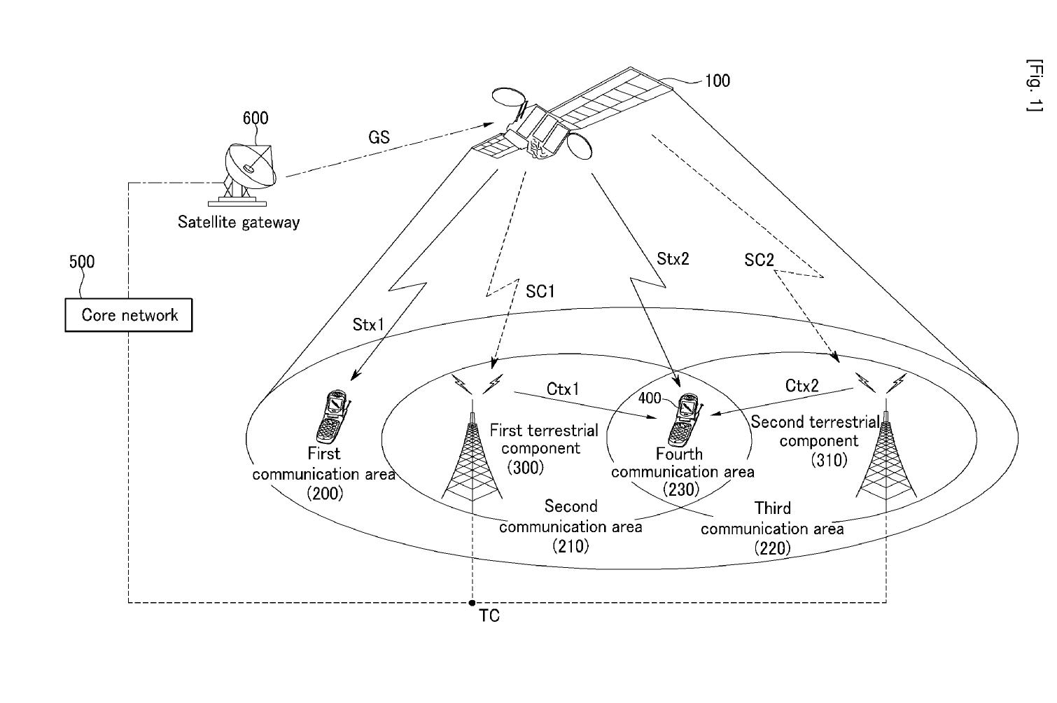

A system environment according to an exemplary embodiment of the present invention is described hereafter with reference to FIG. 1. An exemplary embodiment of the present invention can be applied to any one of broadcasting communication and data communication, but a broadcasting service is described in an exemplary embodiment of the present invention.

FIG. 1 is a diagram illustrating a satellite communication system according to an exemplary embodiment of the present invention.

As shown in FIG. 1, a first communication area 200 is an area where a satellite signal outputted from a satellite 100 is transmitted. A second communication area 210 and a third communication area 220 are areas where signals of a first terrestrial component 300 and a second terrestrial component 310 are transmitted, respectively. A fourth communication area 230 is an interface area that can receive signals transmitted from both the first terrestrial component 300 and the second terrestrial component 310. At least one terminal 400 located in the second communication area 210 to the fourth communication area 230 may receive a satellite signal or may not receive a satellite signal by shadowing.

Further, a dotted line in FIG. 1 indicates a predetermined link for data transmission from a core network 500 to the first terrestrial component 300 or the second terrestrial component 310. Therefore, the first terrestrial component 300 or the second terrestrial component 310 may receive data outputted from the satellite 100 through a first SC link (“SC 1” in FIG. 1) or a second SC link (“SC 2” in FIG. 1), and may receive data through a TC link (“TC” in FIG. 1), a terrestrial network.

The SC link is a communication link through which the satellite 100 is directly connected with the terrestrial component, and the TC link is a link for transmitting data using a terrestrial network connecting the core network 500 with the terrestrial component. Therefore, the terrestrial component 300 or 310 may receive data, which will be transmitted to the terminal 400, through the SC link from the satellite 100 or through the TC link.

An Stx link (“Stx 1” and “Stx 2” in FIG. 1) that is indicated by a thick solid line between the satellite 100 and the terminal 400 is a link for transmitting data from the satellite 100 to the terminal 400. In general, the SC link and the Stx link use different carrier frequencies, but may use the same carrier frequencies. Interference that may be generated when the same frequency resources are used can be removed by data packet scheduling or an interference removing technology, which have been disclosed in the related art and are not described in detail in the exemplary embodiment of the present invention.

Further, a one-directional link connected from a satellite gateway 600 to the satellite 100 through the core network 500 is referred to as a GS link, and a link connected between the first terrestrial component 300 or the second terrestrial component 310 and the terminal 400 is defined as a Ctx link (“Ctx 1” and “Ctx 2” in FIG. 1).

The terminals 400 located in the first communication area 200 to the fourth communication area 220 that are connected with the satellite through the links receive different signals, respectively. That is, the terminal in the first communication area 200 receives a signal from the satellite through the Stx link.

In contrast, the terminal 400 in the second communication area 210 and the third communication area 220 receive a signal transmitted from the first terrestrial component 300 or the second terrestrial component 310 and a signal transmitted from the satellite 100, respectively. The signals transmitted from the terrestrial components 300 and 310 are received through the Ctx link Ctx1 and Ctx2 between the terrestrial components 300 and 310 and the terminal 400, and the signal transmitted from the satellite 100 is received through the Stx link Stx2 between the satellite 100 and the terminal 400.

Further, the terminal 400 in the fourth communication area 230 can receive all of the signals that are transmitted from the satellite 100, the first terrestrial component 300, and the second terrestrial component 310, through the Stx link Stx2, the first Ctx link Ctx1, and the second Ctx link Ctx2. The first Ctx link Ctx1 is a link formed between the terminal 400 in the fourth communication area 230 and the first terrestrial component 300, and the second Ctx link Ctx2 is a link formed between the terminal 400 in the fourth communication area 230 and the second terrestrial component 310.

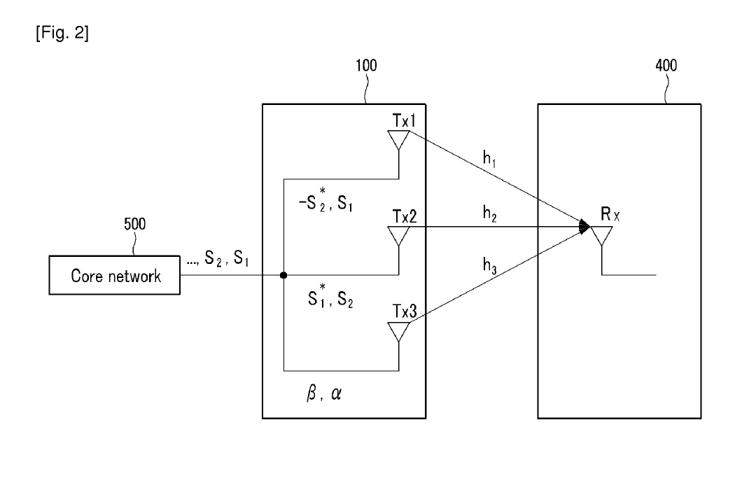

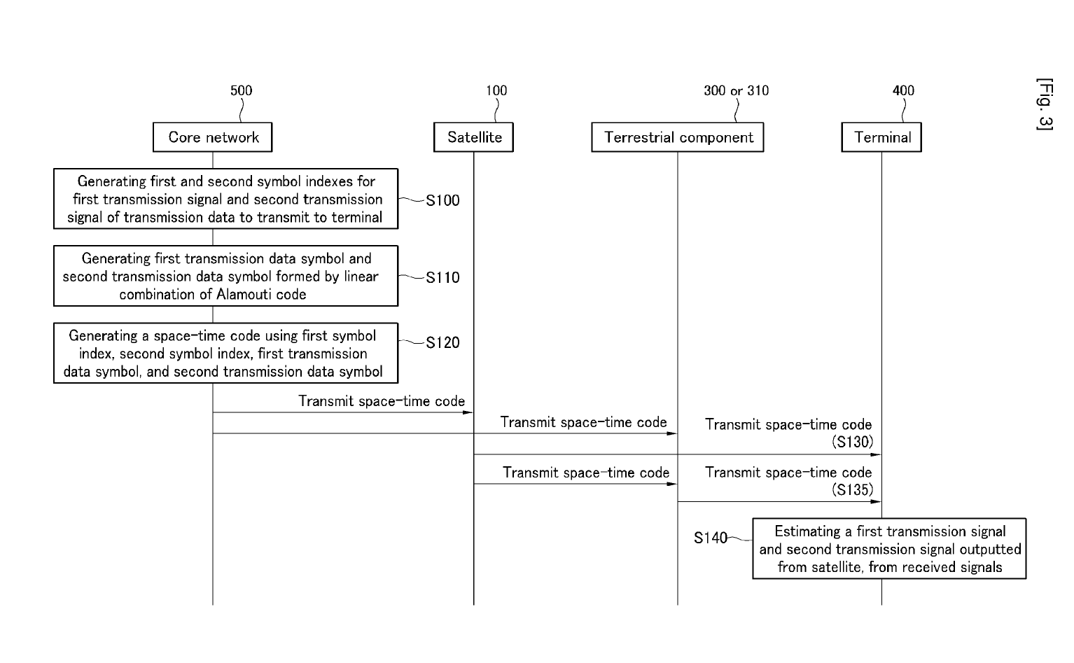

As described above, the signal outputted from the satellite 100 is a signal that can be provided to all of the terminals, regardless of the communication areas. A method of transmitting a space-time code that can improve the entire transmission efficiency for the area with a terrestrial component using the above characteristics can be applied to a system shown in FIG. 2, according to a process illustrated in FIG. 3.

FIG. 2 is a schematic view illustrating a system applying a space-time code according to an exemplary embodiment of the present invention, and FIG. 3 is a flowchart illustrating a method of transmitting/receiving a space-time code according to an exemplary embodiment of the present invention.

As shown in FIG. 2, first, it assumed that as signals that the terminal 400 can receive, there are only a first signal that is transmitted through the Stx link Stx2, a second signal that can be received through the first Ctx link Ctx1, and a third signal that is transmitted through the second Ctx link Ctx2. A space-time code that is used when a signal is transmitted from a terrestrial component 300 or 310 and transmitting terminals Tx1-Tx3 of the satellite 100 to the terminal 400 is generated at the satellite 100, and is expressed by the following Equation 1.

$$( \begin{matrix}{S}_{1} & - {S}_{2}^{*} \\ {S}_{2} & {S}_{1}^{*} \\ α & β\end{matrix} ) \qquad [ Equation 1 ]$$

In Equation 1, the rows indicate space indexes, i.e., ID numbers of antennas that transmit signals. The columns indicate time indexes of transmission signals. Further, S₁ and S₂ indicate symbol indexes of transmission signals. The signal in the first row is outputted from a first transmitting antenna Tx1 and transmitted to a receiving antenna Rx of the terminal 400 through an h₁ channel. Similarly, the signal in the second row is outputted from a second transmitting antenna Tx2 and transmitted to the receiving antenna Rx through an h₂ channel, and the signal in the third row is outputted from a third transmitting antenna Tx3 and transmitted to the receiving antenna Rx through an h₃ channel.

In other words, the core network 500, as shown in FIG. 3, generates a first symbol index and a second symbol index for a first transmitting signal and a second transmitting signal of transmission data that will be transmitted to the terminal 400 (S100). Further, the core network 500 generates a first transmission data symbol and a second transmission data symbol that correspond to α and β in the third row in Equation 1 (S110). The α and β are symbols of transmission data formed by linear combination of the Alamouti code.

In this embodiment, the first symbol index, the second symbol index, the first transmission data symbol, and the second transmission data symbol are generated in the core network 500. However, alternatively, the first symbol index, the second symbol index, the first transmission data symbol, and the second transmission data symbol may be generated in the satellite 100 or terrestrial component 300 or 310.

A space-time code is generally based on the Alamouti code, which is a space-time code for two transmitting antennas. However, because a space-time code is applied under a system environment having three transmitting antennas Tx1-Tx3 in an exemplary embodiment of the present invention, the α and β that are symbol indexes for the third antenna Tx3 are obtained by linear combination of the Alamouti code as following Equation 2

α=As1+Bs2, β=Cs1+Ds2, where A, B, C, and D are arbitrary constants. [Equation 2]

In this embodiment, α and β are any one obtained from the following Equation 3 to

Equation 6. A symbol index obtained from any one of Equation 3 to Equation 6 may be selectively used in system design and in transmitting/receiving a signal, but the invention is not limited thereto.

α=−s₁+s₂, β=s₂*+s₁* [Equation 3]

α=s₁+s₂, β=−s₂*+s₁* [Equation 4]

α=s₁−s₂, β=−s₂*−s₁* [Equation 5]

α=s₁+βs₂, β=−s₂*−s₁* [Equation 6]

A space-time code is generated on the basis of the first symbol index, the second symbol index, the first transmission data symbol, and the second transmission data symbol (S120), and the generated space-time code is transmitted to the satellite 100, thereafter being transmitted to the terminal 400 through the terrestrial component 300 or 310 or directly transmitted to the terminal 400 from the satellite 100 (S130, S135). The space-time code generated at the network 500 may be transmitted to the terrestrial component 300 or 310, which is well known in the related art and is not described in detail in an exemplary embodiment of the present invention.

A received signal that is received by the terminal is expressed as the following Equation 7. The received signal is differently expressed according to the space-time codes in Equation 3 to Equation 6. Therefore, the received signal is expressed by exemplifying the space-time code in Equation 3, in an exemplary embodiment of the present invention.

Signals y₁ and y₂ that are sequentially received by the terminal are expressed as the following Equation 7.

y₁=h₁s₁+h₂s₂+h₃(−s₁+s₂)+h₁

y₂=−h₁s₂*+h₂s₁*+h₃3(s₂*s₁*)+n₂ [Equation 7]

Here, h is a channel and n is noise. Further, data symbols with “*” are conjugate data symbols of corresponding signals.

Equation 7 can be expressed in a vector as the following Equation 8.

Y=HS+N [Equation 8]

Here, Y, H, S, and N are expressed as the following Equation 9.

$$Y = ( \begin{matrix}{y}_{1} \\ {y}_{2}^{*}\end{matrix} ) , H = ( \begin{matrix}( {h}_{1} - {h}_{3} ) & ( {h}_{2} + {h}_{3} ) \\ {( {h}_{2} + {h}_{3} )}^{*} & - {( {h}_{1} - {h}_{3} )}^{*}\end{matrix} ) \\ S = ( \begin{matrix}{s}_{1} \\ {s}_{2}^{*}\end{matrix} ) , N = ( \begin{matrix}{n}_{1} \\ {n}_{2}^{*}\end{matrix} ) \qquad [ Equation 9 ]$$

The terminal 400 estimates a first transmission signal S₁ and a second transmission signal S₂ outputted from the satellite 100, from the received signals (S140), and the first transmission signal and the second transmission signal estimated by the terminal are expressed as the following Equation 10.

Ŝ=H^{H}Y=H^{H}HS+H^{H}N [Equation 10]

Here,

Ŝ=[ŝ₁ŝ₂]^{T}

are values of the first transmission signal S₁ and the second transmission signal S₂ estimated by the terminal 400.

Further, H^{H}H can be arranged as the following Equation 11.

$$( \begin{matrix}{\vert {h}_{1} - {h}_{3} \vert}^{2} + {\vert {h}_{2} + {h}_{3} \vert}^{2} & 0 \\ 0 & {\vert {h}_{1} - {h}_{3} \vert}^{2} + {\vert {h}_{2} + {h}_{3} \vert}^{2}\end{matrix} ) \qquad [ Equation 11 ]$$

In other word, the signals

ŝ₁, ŝ₂

estimated from Equation 10 can be expressed by a product of the data symbol and a channel gain

|h₁−h₃|²+|h₂+h₃|²

That is, the signals can be expressed as the following Equation 12.

ŝ₁=s1*(|h₁−h₃|²+|h₂+h₃|²)

ŝ₂=s2*(|h₁−h₃|²|h₂+h₃|²) [Equation 12]

Therefore, even if a channel of the h₁, h₂, and h₃ has a bad value by fading and the other channels have good values, the signals

ŝ₁, ŝ₂

can be transmitted to the terminal 400, such that the entire transmission system can obtain a diversity gain.

The embodiment of the present invention described above is not implemented by only the method and apparatus, but it may be implemented by a program for executing the functions corresponding to the configuration of the exemplary embodiment of the present invention or a recording medium having recorded thereon the program. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of transmitting a signal to a terminal in a communication system with a plurality of terrestrial components, comprising:
generating a first group of transmission signals on the basis of a first symbol index for a first transmission signal and a second symbol index for a second transmission signal to transmit to the terminal;
generating a second group of transmission signals on the basis of the first symbol index and the second symbol index;
generating a third group of transmission signals on the basis of a first transmission data symbol and a second transmission data symbol that are obtained by operating the first symbol index and the second symbol index; and
generating a space-time code comprising the first group of transmission signals, the second group of transmission signals, and the third group of transmission signals, and transmitting the space-time code to the terminal.

2. The method of claim 1, wherein the first transmission data symbol and the second transmission data symbol are formed by linear combination of an Alamouti code.

3. The method of claim 2, wherein the first transmission data symbol is formed of a data symbol obtained by subtracting the first symbol index from the second symbol index, and the second transmission data symbol is formed of a data symbol obtained by adding a first conjugate symbol index of the first symbol index to a second conjugate symbol index of the second symbol index.

4. The method of claim 2, wherein the first transmission data symbol is formed of a data symbol obtained by adding the first symbol index to the second symbol index, and the second transmission data symbol is formed of a data symbol obtained by subtracting the first conjugate symbol index of the first symbol index from the second conjugate symbol index of the second symbol index.

5. The method of claim 2, wherein the first transmission data symbol is formed of a data symbol obtained by subtracting the second symbol index from the first symbol index, and the second transmission data symbol is formed of a data symbol obtained by adding a negative value of the first conjugate symbol index of the first symbol index to a negative value of the second conjugate symbol index of the second symbol index.

6. The method of claim 2, wherein the first transmission data symbol is formed of a data symbol obtained by adding the first symbol index to the second symbol index, and the second transmission data symbol is formed of a data symbol obtained by adding a negative value of the first conjugate symbol index of the first symbol index to a negative value of the second conjugate symbol index of the second symbol index.

7. The method of claim 1, wherein one of the first group of transmission signals, the second transmission signals, and the third transmission signals is a group of signals that is directly transmitted to the terminal, and the groups of transmission signals other than the group of transmission signals that is directly transmitted to the terminal are transmitted to the terminal through the terrestrial components.

8. The method of claim 7, wherein the terminal is located in one coverage area of coverage areas of the terrestrial components.

9. A method of transmitting a signal to a terminal in a satellite communication system with a plurality of terrestrial components, comprising:
generating a first group of transmission signals that is directly transmitted to the terminal, on the basis of a first symbol index for a first transmission signal and a second symbol index for a second transmission signal to transmit to the terminal;
generating a second group of transmission signals that is transmitted to the terminal through the terrestrial component, on the basis of the first symbol index and the second symbol index;
generating a third group of transmission signals that is transmitted to the terminal through the terrestrial components, on the basis of a first transmission data symbol and a second transmission data symbol that are obtained by operating the first symbol index and the second symbol index; and
generating a space-time code comprising the first group of transmission signals, the second group of transmission signals, and the third group of transmission signals, and transmitting the space-time code to the terminal and the terrestrial components.

10. The method of claim 9, wherein the first transmission data symbol is generated by one of subtracting the first symbol index from the second symbol index, adding the first symbol index to the second symbol index, and subtracting the second symbol index from the first symbol index

11. The method of claim 9, wherein the second transmission data symbol is generated by one of adding a first conjugate symbol index of the first symbol index to a second conjugate symbol index of the second symbol index, subtracting the second conjugate symbol index from the first conjugate symbol index, and adding a negative value of the first conjugate symbol index to a negative value of the second conjugate symbol index.
